(19) United States
(12) Patent Application Publication
(10) Pub. No.: US 2025/0390118 A1
(43) Pub. Date: Dec. 25, 2025

(54) SOLAR MODULE MONITORING FOR TRACKER ANGLE ADJUSTMENT

(71) Applicant: SHOALS TECHNOLOGIES GROUP, LLC, Portland, TN (US)

(72) Inventor: Troy W. Renken, Hendersonville, TN (US)

(21) Appl. No.: 19/233,192

(22) Filed: Jun. 10, 2025

Related U.S. Application Data
(60) Provisional application No. 63/661,835, filed on Jun. 19, 2024.

(51) Int. Cl. G05D 3/10; H02J 3/38; H02S 20/32; H02S 50/00

(52) U.S. Cl. CPC G05D 3/105; H02J 3/381; H02S 20/32; H02S 50/00; H02J 2300/26

(57) ABSTRACT

In an example, a method of tracker angle adjustment based on solar module monitoring includes obtaining, at different angular positions of a tracker throughout a day, a current measurement and a voltage measurement of a solar module in a row of solar modules coupled to the tracker. The method includes, for each of the different angular positions of the tracker, calculating a power of the solar module based on the current measurement and the voltage measurement obtained for the tracker at a corresponding one of the different angular positions. The method includes periodically adjusting the tracker to a new angular position for ongoing operation until a next periodic adjustment based on calculated powers of the solar module for the tracker at different positions.

### CROSS-REFERENCE TO RELATED APPLICATION

This application claims the benefit of and priority to U.S. Provisional Patent Application No. 63/661,835 filed on Jun. 19, 2024. The application 63/661,835 is incorporated herein by reference in its entirety.

### FIELD

Embodiments described herein relate to solar module monitoring for tracker angle adjustment.

### BACKGROUND

Unless otherwise indicated in the present disclosure, the materials described in the present disclosure are not prior art to the claims in the present application and are not admitted to be prior art by inclusion in this section.

Solar trackers utilized in renewable energy production are devices that track the motion of the sun relative to the earth to maximize the production of solar energy. Solar trackers move to generally keep solar modules perpendicular to the sun in either one or two axes. The solar modules may include photovoltaic (PV) modules (e.g., modules that convert solar energy to electrical energy), solar thermal modules (e.g., modules that convert solar energy to thermal energy), or solar modules that convert solar energy to some other form.

The energy gain provided by solar trackers depends on the tracking geometry of the system and the location of the installation. A dual axis (D/A) solar tracker keeps the solar module perpendicular to the sun in two axes and provides the greatest gain in energy production at any location. Single axis (S/A) solar trackers are fixed in one axis and typically track the daily motion of the sun in the other axis. S/A solar tracker geometries include tilted elevation, azimuth, and horizontal. Tilted elevation S/A trackers are tilted as a function of the location's latitude and track the sun's daily motion about that tilted axis. Azimuth S/A solar trackers are tilted at an optimum angle and follow the daily motion of the sun by rotating about the vertical axis. Horizontal S/A solar trackers are configured parallel to the ground and rotate about a North/South horizontal axis to track the sun's daily motion. The energy gained varies for each type of tracking geometry and is dependent upon the latitude of the installation and the weather conditions at the installation location. Solar tracking systems for solar modules are commercially available in a variety of geometries, including S/A tilt and roll, S/A horizontal, S/A fixed tilt azimuth, and D/A geometries.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Some embodiments of the present disclosure collect live current and voltage information for each string or row of solar modules for a tracker system to optimize solar module angular position at a more granular level than existing systems for maximum power. The tracker system may periodically adjust the angle of all strings and/or rows based on a lookup table or other base algorithm and then further adjust individual strings or rows based on feedback from one or more measurement devices per string or row to maximize, or at least increase or improve, energy capture per string or row

In an example, a method of tracker angle adjustment based on solar module monitoring includes obtaining, at different angular positions of a tracker throughout a day, a current measurement and a voltage measurement of a solar module in a row of solar modules coupled to the tracker. The method includes, for each of the different angular positions of the tracker, calculating a power of the solar module based on the current measurement and the voltage measurement obtained for the tracker at a corresponding one of the different angular positions. The method includes periodically adjusting the tracker to a new angular position for ongoing operation until a next periodic adjustment based on calculated powers of the solar module for the tracker at different positions.

In another example, a method of tracker angle adjustment based on solar module monitoring includes periodically adjusting an angular position of a tracker having a row of solar modules coupled thereto throughout a day. The foregoing includes, for each periodic adjustment: obtaining a current measurement and a voltage measurement of one of the solar modules in the row at each of multiple different angular positions of the tracker; calculating different powers of the one of the solar modules corresponding to the different angular positions of the tracker, each of the different powers determined based on the current measurement and the voltage measurement for the tracker at a given one of the different angular positions; and positioning the tracker at an angular position for ongoing operation until a next periodic adjustment based on the different powers.

In another example, a method of tracker angle adjustment based on solar module monitoring includes periodically adjusting an angular position of a tracker having a row of solar modules coupled thereto throughout a day according to a pre-set schedule based on a lookup table for a given location. The lookup table specifies optimal tracker angular positions at the given location for different days and times. The method includes, before each adjustment, obtaining a pre-adjustment current measurement and voltage measurement of one of the solar modules of the row for the tracker at a pre-adjustment angular position. The method includes adjusting the tracker angular position to an initial adjusted angular position specified as the optimal tracker angular position in the lookup table for a current day and current time. The method includes obtaining an initial adjusted current measurement and voltage measurement of the one of the solar modules of the row for the tracker at the initial adjusted angular position. The method includes adjusting the tracker angular position to a further adjusted angular position beyond the initial adjusted angular position. The method includes obtaining a further adjusted current measurement and voltage measurement of the one of the solar modules of the row for the tracker at the further adjusted angular position. The method includes calculating a pre-adjustment power, an initial adjusted power, and a further adjusted power of the one of the solar modules at each of the pre-adjustment angular position, the initial adjusted angular position, and the further adjusted angular position from the current measurement and voltage measurement obtained at each angular position. The method includes, in response to the initial adjusted power being greater than each of the pre-adjustment power and the further adjusted power, adjusting the tracker angular position back to the initial adjusted angular position and keeping the tracker at the initial adjusted angular position until a next periodic adjustment of the tracker angular position according to the lookup table.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example solar array that includes solar trackers and PV modules;

FIG. 2 is a flowchart of an example method to adjust tracker angle;

FIG. 3 is a flowchart of another example method to adjust tracker angle;

FIG. 4 is a flowchart of another example method to adjust tracker angle;

FIG. 5 is a block diagram of an example computing system suitable for use in implementing some embodiments of the present disclosure,

all according to at least one embodiment described in the present disclosure.

### DESCRIPTION OF EMBODIMENTS

Solar tracker manufacturers desire to position solar modules to generate maximum power. The National Renewable Energy Laboratory (NREL) has generated a Solar Position Algorithm (SPA) which details solar zenith and azimuth angles based on the date, time, and location on earth. The NREL's SPA may serve as the foundation of tracker position algorithms.

Some tracker solutions adjust an entire array (e.g., multiple rows) of solar modules together to track the sun and thereby maximize power output. In particular, the angle of a tracker may be adjusted periodically (e.g., once every 5 minutes, once every 10 minutes, once every 15 minutes, once every 20 minutes, or other frequency) to an optimum angle at which the solar modules are as perpendicular as possible to incoming light from the sun to maximize energy capture at the solar modules. Such trackers typically have a lookup table (based on the NREL's SPA) that specifies the optimum angle for a given time on a given day at a given location (i.e., the location of the solar modules); the trackers may periodically lookup the optimum angle based on the current day and time (for the given location) and then adjust to the optimum angle. Such solutions are applied system-wide (e.g., to every string of modules), do not have resolution down to the string level, and do not incorporate any feedback. Getting resolution down to the string level and/or incorporating current, voltage, and/or other measurements as feedback may improve energy capture and thereby power generation from a solar field or array.

The NREL's SPA is deficient for a number of reasons. For example, the SPA fails to account for or consider topology. For example, different rows or strings of solar modules may be at different elevations. The SPA also fails to account for or consider bifacial solar modules, i.e., solar modules that have two active faces (e.g., a front and a back), both of which may capture and convert sunlight to electricity. The SPA also fails to account for or consider shading from surrounding structures. The SPA's failure to account for or consider many factors that can affect power output leaves significant room for improvement.

Some embodiments herein collect live current and voltage information for each string or row of solar modules so that the tracker system can optimize the solar module angular position at a more granular level than existing systems for maximum power. In some embodiments, the tracker system may periodically adjust the angle of all strings and/or rows based on a lookup table or other base algorithm or procedure, and then further adjust individual strings or rows based on feedback (e.g., current, voltage, and/or other measurements) from one or more measurement devices per string or row to maximize, or at least increase or improve, energy capture per string or row. Accordingly, embodiments herein may account for and/or consider elevation, albedo (e.g., incident light reflected by other surfaces towards one or both active surfaces of bifacial modules), shading, and/or other factors that may vary from one string or row to another to increase power output in solar arrays beyond what is currently possible under existing approaches (e.g., lookup tables).

Embodiments of the present disclosure will be explained with reference to the accompanying drawings.

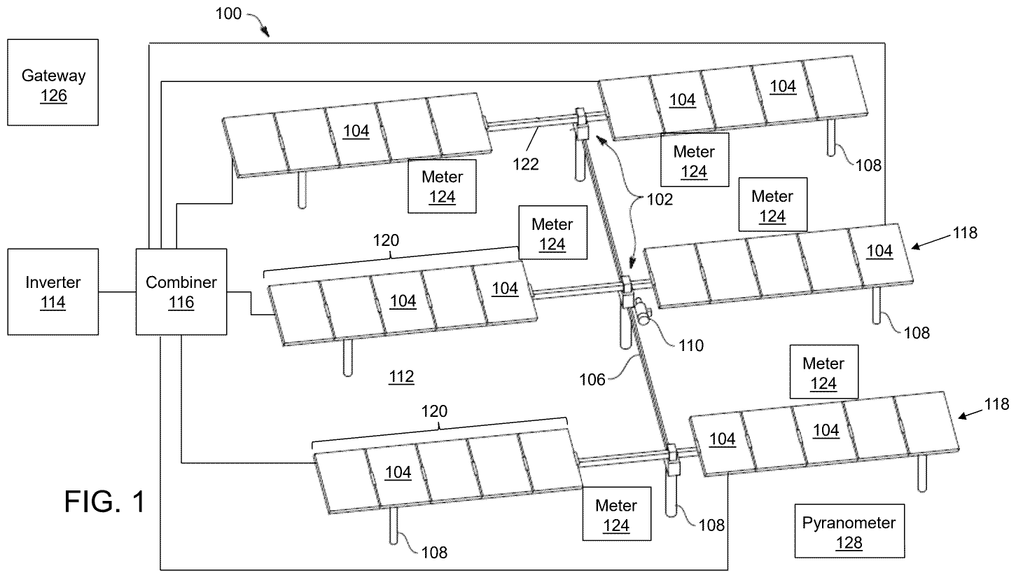

FIG. 1 illustrates an example solar array 100 that includes solar trackers 102 and PV modules 104, arranged in accordance with at least some embodiments herein. Only some of the solar trackers 102 and PV modules 104 are labeled for simplicity. This labeling convention is implemented for all components in all figures herein. The solar array 100 further includes drive linkages 106, support columns 108, and drive mechanism 110. The drive mechanism 110 may include a drive motor or other suitable drive mechanism. The drive linkages 106 transmit mechanical power generated by the drive mechanism 110 between solar trackers 102. The support columns 108 support the solar trackers 102 and/or PV modules 104 above an installation surface 112. The installation surface 112 may include ground, a roof of a building or surface of other structure, or other suitable installation surface. The PV modules 104 may be electrically coupled to an inverter 114, e.g., through one or more combiner boxes 116. FIG. 1 illustrates only one possible implementation of the solar array 100. In other embodiments, for example, the solar array 100 may omit the drive linkages 106 and instead include a different drive mechanism 110 on each tracker 102, e.g., on each of the three rows in the example of FIG. 1.

The PV modules 104 may be arranged in rows 118 and strings 120. A “row” 118 of PV modules 104 refers to a mechanical arrangement of PV modules 104. In this example, a “row” of PV modules 104 refers to all of the PV modules 104 attached to a given torque tube 122 and which must necessarily rotate together during rotational adjustments of a corresponding solar tracker 102. A “string” 120 of PV modules 104 refers to an electrical arrangement of PV modules 104 in which all of the PV modules 104 in a given string 120 are electrically coupled together in series. In some embodiments, each row 118 of PV modules 104 may include one or more strings 120 of PV modules 104. As illustrated, for example, each row 118 in FIG. 1 includes two strings 120.

In some embodiments, the PV modules 104 are monofacial, or single-sided, meaning they have a single surface with an active material that converts incoming light to electricity, which surface includes a generally front and/or upper surface as visible in the example of FIG. 1. In other embodiments, the PV modules 104 may include bifacial PV modules 104. A bifacial PV module has active material on two opposing faces, including the generally front and/or upper surface in FIG. 1, as well as an opposing generally bottom or back surface not visible in FIG. 1.

In some systems, inverters such as the inverter 114 perform maximum power point tracking (MPPT) on an entire array such as the solar array 100. The problem addressed by MPPT is that the efficiency of power transfer from the PV modules 104 collectively depends on the amount of available sunlight, shading, solar panel temperature and a load's (i.e., the inverter's 114) electrical characteristics. As these conditions vary, the load characteristic (impedance) that gives the highest power transfer changes. The point of MPPT is to change the load characteristic to keep power transfer at the highest efficiency. In an example MPPT algorithm, the inverter 114 measures voltage and current coming from the entire solar array 100 and then operates its direct current (DC)-to-DC converter to put the right load (e.g., the load that will result in highest (or close to highest) efficiency power transfer) on the PV modules 104. Performing MPPT on an entire array occurs at a high level.

Whether the inverter 114 performs MPPT on the entire solar array 100 or not, the solar trackers 102 in some systems may adjust all rows 118 of PV modules 104 at the same time based on, e.g., lookup tables. As a result, in such systems the PV modules 104 are not treated as individual rows 118 or with direct measurement to achieve the maximum energy capture, which in turn may translate to maximum power output at the inverter (e.g., when combined with MPPT).

Some systems also implement current monitoring of strings 120 but not voltage monitoring of individual PV modules 104. Since voltage is not known, the maximum power point cannot be calculated at the PV module 104 level. Such current monitors may measure string 120 voltage but it has been done at the combiner 116 where multiple strings 120 of PV modules 104 are all connected and without monitoring voltage at any given one(s) of the PV modules 104.

Other systems omit the combiner 116 altogether, instead collecting power from the strings 120 using a trunk bus system such as SHOAL's big lead assembly (BLA). With such trunk bus systems, it may be even more difficult to monitor individual string current and/or string voltage.

Accordingly, some embodiments herein further include a current and voltage (I-V) meter 124 coupled to each string 120 of PV modules 104 (and/or to one or more individual PV modules 104) and provide a gateway 126 with which the I-V meters 124 may communicate. The I-V meters 124 and the gateway 126 may communicate using any suitable wired or wireless protocol, including one or more of Bluetooth, Zigbee, WiFi (IEEE 802.11 family of protocols), any mobile telephony standard (e.g., LTE, LTE-A, 5G, etc.), sub-Gig frequencies for wireless, RS-485, SCADA, or the like or any combination thereof. The I-V meters 124 may monitor, measure, record, store, communicate, or otherwise process or handle live (e.g., real-time) voltage and current for their corresponding string 120 of PV modules 104 and/or individual PV modules 104. Examples of the I-V meters 124 may include the SNAPSHOT I-V meter available from SHOALS, although other I-V meters 124 may alternatively or additionally be implemented. Example aspects of I-V meters which may be implemented herein are disclosed in U.S. application Ser. No. 18/786,074 filed Jul. 26, 2024, which is incorporated herein by reference in its entirety.

The I-V meters 124 may monitor live voltage and current for their respective strings 120 and communicate this information wirelessly to the gateway 126. When the tracker 102 prepares to adjust the angle position of a row 118 (single string 120 or multi-string 120), the tracker 102 may get (e.g., from or through the gateway 126) a current and voltage reading, and/or a power measurement or calculation (where power equals voltage times current), from the string 120 being monitored. The current and voltage are measured by the I-V meter 124 coupled to one of the PV modules 104 of the string 120 and are specifically for the PV module 104 to which the I-V meter 124 is coupled. Since all of the PV modules 104 of the string 120 are electrically coupled in series, all of the PV modules 104 of the string 120 will have the same current as measured by the I-V meter 124. The voltage measurement is specific to the PV module 104 to which the I-V meter 124 is coupled since the PV modules 104 are electrically in series, although the voltage measurement may at least approximate the actual voltage of each of the other PV modules 104 in the string 120. In some embodiments, each row 118 may include two or more strings 120, in which case the tracker 102 may obtain a current and voltage measurement, and/or power measurement or calculation, for each string 120 (and specifically for the given PV modules 104 in the strings 120 to which the corresponding I-V meters 124 are coupled) in the row 118. Where the power measurement or calculation is obtained, the power measurement or calculation may be for the given specific PV module 104 to which the I-V meter 124 is coupled. This may be used to extrapolate a power measurement or calculation for the entire string 120 that includes the specific PV module 104 (e.g., by multiplying the power measurement or calculation by the number of PV modules 104 in the string 120), or may be used as is. In the discussion that follows, it is assumed that current measurements and voltage measurements are obtained with the understanding that instead power measurements or calculations may be obtained.

After obtaining the current measurement and the voltage measurement from the I-V meter 124 (or after obtaining multiple pairs of a current measurement and a voltage measurement from multiple I-V meters 124 for a row 118 with two or more strings 120), the angle of the row 118 may then be adjusted to an initial adjusted angular position, e.g., as specified in a lookup table. The current measurement and the voltage measurement (or multiple pairs of current measurement and voltage measurement) may be repeated at the initial adjusted angular position, followed by further adjusting the angle (e.g., in the same direction as the first adjustment) to a further adjusted angular position, followed by repeating the current measurement and the voltage measurement (or multiple pairs of current measurement and voltage measurement) at the further adjusted angular position. This results in three sets of current and voltage measurements, each set corresponding to a different one of three angular positions including a pre-adjustment angular position, the initial adjusted angular position, and the further adjusted angular position. The power at each position may be calculated as the product of the current and voltage measurements at that position. The three powers may then be compared to determine which is highest. If the middle position, i.e., the initial adjusted angular position, has the highest power of the three positions, the row 118 may be rotated back to the initial adjusted angular position to remain until it is time for the next adjustment, e.g., according to the lookup table. If the middle position does not have the highest power, one or more further angular adjustments and corresponding current and voltage measurements may be made in the direction of the position with the highest power. For example, if the further adjusted angular position has the highest power of the three positions, the row 118 may be rotated another step to a fourth position, further measurements may be made, the power may be calculated, and the powers at the initial adjusted angular position, the further adjusted angular position, and the fourth position may then be compared. If the middle position of the three, i.e., the further adjusted angular position, has the highest power of the three positions, the row 118 may be rotated back to the further adjusted angular position to remain until it is time for the next adjustment. As another example, if the pre-adjustment angular position has the highest power of the three positions, the row 118 may be rotated back to the pre-adjustment angular position. The tracker 102 may have a fixed step size or a variable step size.

In embodiments in which a given one of the rows 118 includes multiple strings 120, the tracker 102 may consider the power calculations from all of the strings 120 within a given row when determining where to position the row 118. For example, the tracker 102 may sum or average power calculations across strings 120 in the row 118 at each position, compare the calculated power sums or averages for the three positions, and move the row 118 back to the middle position if it has the highest calculated power sum or average of the three positions, and the like.

Alternatively or additionally, one or more strings 120 or rows 118 may include two or more I-V meters 124, including a first I-V meter 124 for a first PV module 104 in the string 120 or row 118 and a second I-V meter 124 for a second PV module 104 in the string 120 or row 118. In this example, the current and/or voltage measurements from the two or more I-V meters 124 of the string 120 or row 118 may be summed or averaged and the sum or average may be used in the methods described herein instead of or in addition to the current and/or voltage measurements from a single I-V meter 124 per string 120 or row 118 as described above. Alternatively or additionally, where a string 120 has two or more I-V meters 124, the methods herein may determine which I-V meter 124 has output the highest measurement(s) and use those measurements in the methods described herein.

In some embodiments, the solar array 100 may further include a pyranometer 128. The pyranometer 128 may be mounted vertically on a pole near the solar array in a fixed static position or one or more pyranometers 128 may be mounted to one or more of the torque tubes 122. The pyranometer 128 may measure irradiance at the PV modules 104. Pyranometer data output by the pyranometer 128 may be recorded and/or provided to the solar trackers 102, e.g., through the gateway 126, along with each current measurement and voltage measurement to record current/voltage at the same irradiance level. When mounted to the torque tube 122, the pyranometer data may include irradiance measurements at each angular position of the torque tube and may be used to ensure the voltage and current measurements occur under the same or similar irradiance conditions. For example, if one of the voltage and current measurements was made as a cloud passed over, the pyranometer measurements may facilitate detection of this condition and the system may rotate back to the corresponding angular position to retake the voltage and current measurements until they are taken under the same or similar irradiance conditions as the other voltage and current measurements. In some embodiments, multiple voltage and current measurements (and irradiance measurements) may be taken at each angular position to increase odds of having at least one current and voltage measurement at each of the various angular positions that was taken under similar irradiance conditions as the other angular positions. Alternatively or additionally, the algorithm may consider both power calculations and irradiance measurements, may weight one more than the other, may completely ignore one over the other, or may process the power calculations and irradiance measurements in some other manner.

Embodiments herein measure and collect string 120 current and voltage to calculate maximum power. In prior systems, utility scale solar fields have monitored string 120 current but not voltages of solar modules in the string 120, so module-level power could not be calculated. Thus, embodiments herein enable trackers to further optimize energy capture.

In some embodiments, the current and voltage measurements output by the I-V meters 124 and/or the irradiance measurements output by the pyranometer 128 may be provided to the inverter 114. The inverter 114 may use the measurements to monitor strings 120, verify how an MPPT algorithm implemented by the inverter 114 is reacting in the solar array 100, or the like. Alternatively or additionally, the measurements may help the inverter 114 determine how frequently to adjust impedance within the MPPT algorithm, or the like. In some embodiments, the inverter 114 may hold MPPT constant during each testing cycle (e.g., while measuring voltage and current at each of multiple angular positions) so load conditions do not change during each testing cycle.

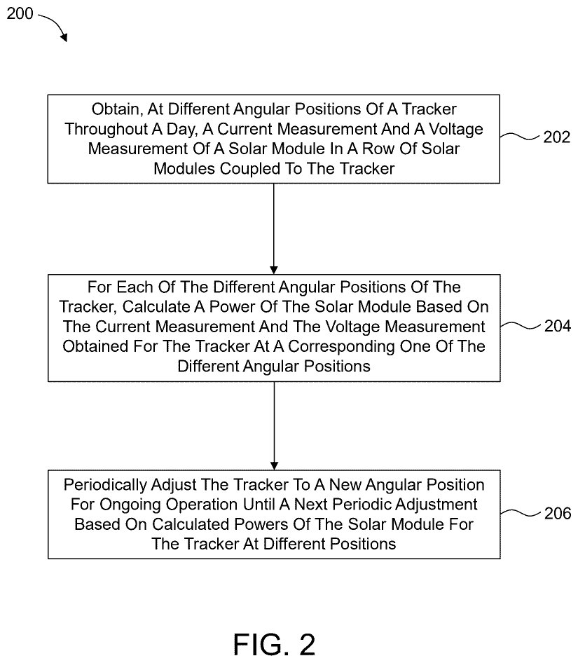

FIG. 2 is a flowchart of an example method 200 to adjust tracker angle (or position, or angular position), arranged in accordance with at least one embodiment herein. The method 200 may be implemented at or by a solar tracker, such as any of the trackers 102 of FIG. 1. Alternatively or additionally, the method 200 may be performed or controlled by a processor or other computing device or computing system of the tracker 102. In some embodiments, the method 200 may be performed at multiple trackers 102 simultaneously. In some embodiments, the method 200 may be performed in the trackers 102 one at a time to avoid many variables changing at once for the solar array 100. In some embodiments, the method 200 may be performed in each tracker 102 every time the tracker 102 moves. In some embodiments, the method 200 may be performed in each tracker periodically (e.g., weekly, monthly, etc.) to fine tune the tracker algorithm and create a new lookup table customized to the site of the solar array 100. The method 200 may include one or more of blocks 202, 204, and/or 206.

At block 202, the method 200 may include obtaining, at different angular positions of a tracker throughout a day, a current measurement and a voltage measurement of a solar module in a row of solar modules coupled to the tracker. In some embodiments, block 202 may include obtaining at least three current and voltage measurements each time the tracker is to be adjusted. For example, the tracker may receive first current and voltage measurements from a PV module in a row of PV modules coupled to the tracker for the tracker at a pre-adjustment angular position; second current and voltage measurements from the PV module for the tracker at an initial adjusted angular position (e.g., an optimal angular position specified in a lookup table for the location of the tracker, the current day, and the current time), and third current and voltage measurements from the PV module for the tracker at a further adjusted angular position (e.g., at one step or increment beyond the initial adjusted angular position). The tracker may move to further one or more angular positions and obtain one or more additional current and voltage measurements at each position in some circumstances (e.g., if a calculated power for the tracker at the initial adjusted angular position is not higher than calculated powers for the tracker at the other two angular positions). Block 202 may be followed by block 204.

At block 204, the method 200 may include, for each of the different angular positions of the tracker, calculating a power of the solar module based on the current measurement and the voltage measurement obtained for the tracker at a corresponding one of the different angular positions. Block 204 may be followed by block 206.

At block 206, the method 200 may include periodically adjusting the tracker to a new angular position for ongoing operation until a next periodic adjustment based on calculated powers of the solar module for the tracker at different positions. In some embodiments, the new angular position has a calculated power that is greater than a calculated power for the tracker at a first adjacent angular position to one side of the new angular position and greater than a calculated power for the tracker at a second adjacent angular position to an opposite side of the new angular position.

In some embodiments, periodically adjusting the tracker to the new angular position at block 204 may be based on at least three calculated powers for the solar module. The three calculated powers may include a first calculated power with the tracker at a pre-adjustment angular position, a second calculated power for the tracker at an initial adjusted angular position, and a third calculated power for the tracker at a further adjusted angular position. The new angular position may correspond to the pre-adjustment angular position, the initial adjusted angular position, or the further adjusted angular position with a highest calculated power.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

For example, the method 200 may further include obtaining an irradiance measurement at different angular positions of the tracker throughout the day. In these and other embodiments, periodically adjusting the tracker to the new angular position for ongoing operation until the next periodic adjustment at block 206 may be further based on one or more of such irradiance measurements.

In some embodiments, the method 200 may further include periodically adjusting the tracker to the new angular position for ongoing operation until the next periodic adjustment based on a lookup table specific to a location of the tracker. The lookup table may specify optimal tracker angular positions for specific days and times at the location. For any given periodic adjustment, the calculated powers may include a calculated power for the tracker at an optimum tracker angular position specified in the lookup table for a current day and time. Alternatively or additionally, for any given periodic adjustment, the calculated powers may include a calculated power for the tracker at an angular position to one side of the optimum tracker angular position and/or a calculated power for the tracker at another angular position to an opposite side of the optimum tracker angular position.

In some embodiments, the method 200 may be performed for or using measurements from two or more solar modules in a row of solar modules coupled to the tracker. For example, at block 202, the method 200 may include obtaining, at different angular positions, current and voltage measurements of a first solar module and a second solar module in a same row of solar modules. Block 204 may include calculating a power of each of the first and second solar modules at each of the angular positions. The method 200 may also include calculating a sum or an average of the calculated powers at each angular position or determining which of the calculated powers at each angular position is greater. Block 206 may include periodically adjusting the tracker to the new angular position based on the sums of the calculated powers, the averages of the calculated powers, or the greatest calculated powers.

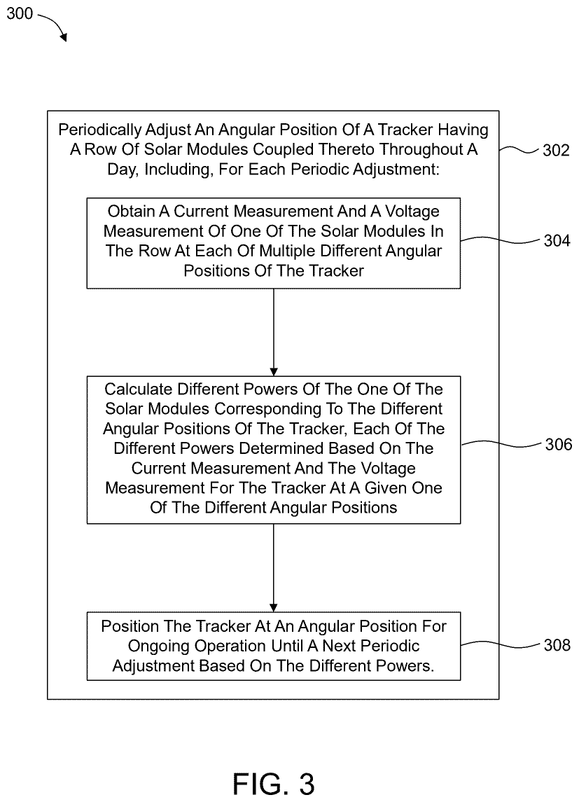

FIG. 3 is a flowchart of another example method 300 to adjust tracker angle (or position, or angular position), arranged in accordance with at least one embodiment herein. The method 300 may be implemented at or by a solar tracker, such as any of the trackers 102 of FIG. 1. Alternatively or additionally, the method 300 may be performed or controlled by a processor or other computing device or computing system of the tracker 102. The method 300 may include one or more of blocks 302, 304, 306, and/or 308.

At block 302, the method 300 may include periodically adjusting an angular position of a tracker having a row of solar modules coupled thereto throughout a day. Block 302 may include one or more of blocks 304, 306, and/or 308. Alternatively or additionally, block 302 may further include, for each periodic adjustment, looking up an optimal tracker angular position for a current day and current time in a lookup table that specifies optimal tracker angular positions for different days and times at a location of the tracker.

Block 304 may include obtaining a current measurement and a voltage measurement of one of the solar modules in the row at each of multiple different angular positions of the tracker, such as the pre-adjustment angular position, the initial adjusted angular position, and the further adjusted angular position discussed elsewhere herein. In some embodiments, for each periodic adjustment, the multiple different angular positions of the tracker at which the current measurement and the voltage measurement of the solar modules are obtained may include the optimal tracker angular position in the lookup table for the current day and current time. The optimal tracker angular position may include or correspond to the initial adjusted angular position discussed elsewhere herein. Block 304 may be followed by block 306.

Block 306 may include calculating different powers of the solar module corresponding to the different angular positions of the tracker. Each of the different powers may be determined based on the current measurement and the voltage measurement for the tracker at a given one of the different angular positions. Block 306 may be followed by block 308.

Block 308 may include positioning the tracker at an angular position for ongoing operation until a next periodic adjustment based on the different powers.

In some embodiments, the angular position at which the tracker is positioned for ongoing operation until the next periodic adjustment may have a calculated power that is greater than a calculated power for the tracker at a first adjacent angular position to one side of the angular position and greater than a calculated power for the tracker at a second adjacent angular position to an opposite side of the angular position.

Alternatively or additionally, the different powers calculated for each periodic adjustment may include at least a first calculated power for the tracker at the pre-adjustment angular position, a second calculated power for the tracker at the initial adjusted angular position, and a third calculated power for the tracker at the further adjusted angular position. The angular position at which the tracker is positioned for ongoing operation until the next periodic adjustment may correspond to the pre-adjustment angular position, the initial adjusted angular position, or the further adjusted angular position with a highest calculated power.

In some embodiments, the method 300 may further include obtaining an irradiance measurement at different angular positions of the tracker throughout the day. In these and other embodiments, positioning the tracker at the angular position for ongoing operation until the next periodic adjustment may be further based on one or more irradiance measurements.

In some embodiments, the method 300 may be performed for or using measurements from two or more solar modules in a row of solar modules coupled to the tracker. For example, at block 304, the method 300 may include obtaining a current measurement and a voltage measurement from each of two or more solar modules in the row at each of multiple different angular positions of the tracker. Block 306 may include calculating a power of each of the two or more solar modules at each of the angular positions. The method 300 may also include calculating a sum or an average of the calculated powers at each angular position or determining which of the calculated powers at each angular position is greater. Block 308 may include positioning the tracker at an angular position for ongoing operation based on the sums of the calculated powers, the averages of the calculated powers, or the greatest calculated powers.

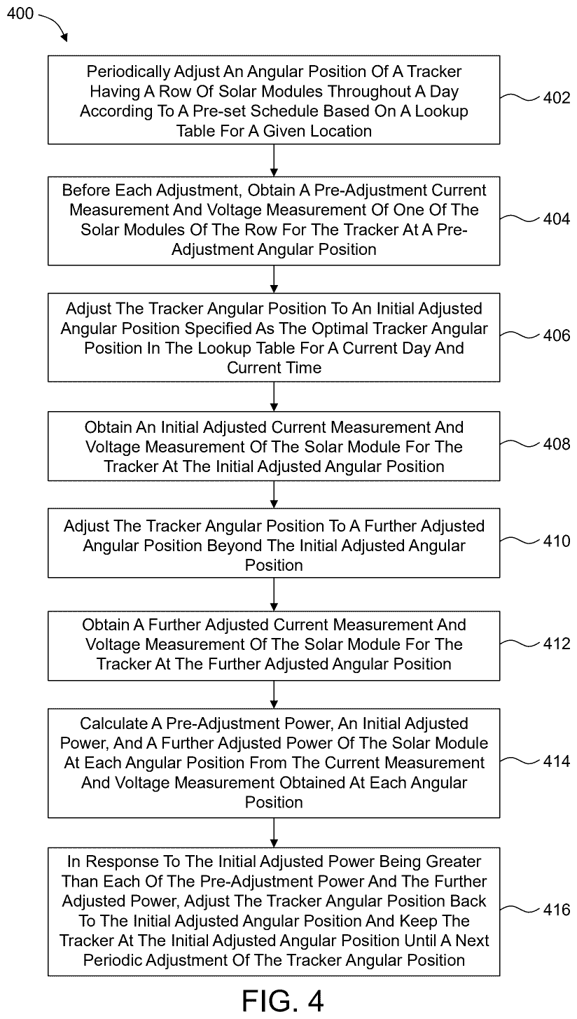

FIG. 4 is a flowchart of another example method 400 to adjust tracker angle (or position, or angular position), arranged in accordance with at least one embodiment herein. The method 400 may be implemented at or by a solar tracker, such as any of the trackers 102 of FIG. 1. Alternatively or additionally, the method 400 may be performed or controlled by a processor or other computing device or computing system of the tracker 102. The method 400 may include one or more of blocks 402, 404, 406, 408, 410, 412, 414, and/or 416.

At block 402, the method 400 may include periodically adjusting an angular position of a tracker having a row of solar modules coupled thereto throughout a day according to a pre-set schedule based on a lookup table for a given location. The lookup table may specify optimal tracker angular positions at the given location for different days and times. Block 402 may be followed by block 404.

At block 404, the method 400 may include, before each periodic adjustment, obtaining a pre-adjustment current measurement and voltage measurement of one or more of the solar modules of the row for the tracker at a pre-adjustment angular position. Block 404 may be followed by block 406.

At block 406, the method 400 may include adjusting the tracker angular position to an initial adjusted angular position specified as the optimal tracker angular position in the lookup table for a current day and current time. Block 406 may be followed by block 408.

At block 408, the method 400 may include obtaining an initial adjusted current measurement and voltage measurement of each of the one or more solar modules for the tracker at the initial adjusted angular position. Block 408 may be followed by block 410.

At block 410, the method 400 may include adjusting the tracker angular position to a further adjusted angular position beyond the initial adjusted angular position. Block 410 may be followed by block 412.

At block 412, the method 400 may include obtaining a further adjusted current measurement and voltage measurement of each of the one or more solar modules for the tracker at the further adjusted angular position. Block 412 may be followed by block 414.

At block 414, the method 400 may include calculating a pre-adjustment power, an initial adjusted power, and a further adjusted power of each of the one or more solar modules at each of the pre-adjustment angular position, the initial adjusted angular position, and the further adjusted angular position from the current measurement and voltage measurement obtained at each angular position. Block 414 may be followed by block 416.

At block 416, the method 400 may include, in the case of calculating the pre-adjustment power, initial adjusted power, and further adjusted power for a single solar module at block 414, in response to the initial adjusted power being greater than each of the pre-adjustment power and the further adjusted power, adjusting the tracker angular position back to the initial adjusted angular position and keeping the tracker at the initial adjusted angular position until a next periodic adjustment of the tracker angular position according to the lookup table.

At block 416, the method 400 may include, in the case of calculating the pre-adjustment power, initial adjusted power, and further adjusted power for each of two or more solar modules of the row at block 414, in response to an average of the initial adjusted powers being greater than each of an average of the pre-adjustment powers and an average of the further adjusted powers, adjusting the tracker angular position back to the initial adjusted angular position and keeping the tracker at the initial adjusted angular position until a next periodic adjustment of the tracker angular position according to the lookup table.

Alternatively, at block 416, the method 400 may include, in the case of calculating the pre-adjustment power, initial adjusted power, and further adjusted power for each of two or more solar modules of the row at block 414 and determining that a first solar module of the two or more solar modules has higher power calculations than other solar modules of the two or more solar modules, in response to the initial adjusted power of the first solar module being greater than each of the pre-adjustment power of the first solar module and the further adjusted power of the first solar module, adjusting the tracker angular position back to the initial adjusted angular position and keeping the tracker at the initial adjusted angular position until a next periodic adjustment of the tracker angular position according to the lookup table.

In some embodiments, the method 400 may further include, in response to the further adjusted power being greater than each of the pre-adjustment power and the initial adjusted power, adjusting the tracker angular position to a third adjusted angular position beyond the further adjusted angular position. The method 400 may further include obtaining a third adjusted current measurement and voltage measurement of the solar module for the tracker at the third adjusted angular position. The method 400 may further include calculating a third adjusted power of the solar module at the third adjusted angular position from the third adjusted current measurement and voltage measurement obtained at the third adjusted angular position. The method 400 may further include, in response to the further adjusted power being greater than each of the initial adjusted power and the third adjusted power, adjusting the tracker angular position back to the further adjusted angular position and keeping the tracker at the further adjusted angular position until the next periodic adjustment of the tracker angular position according to the lookup table.

Alternatively or additionally, the method 400 may further include obtaining irradiance measurements for the tracker at the pre-adjustment angular position, the initial adjusted angular position, and the further adjusted angular position. In this and other embodiments, adjusting the tracker angular position back to the initial adjusted angular position and keeping the tracker at the initial adjusted angular position until the next periodic adjustment at block 416 is further based on the irradiance measurements.

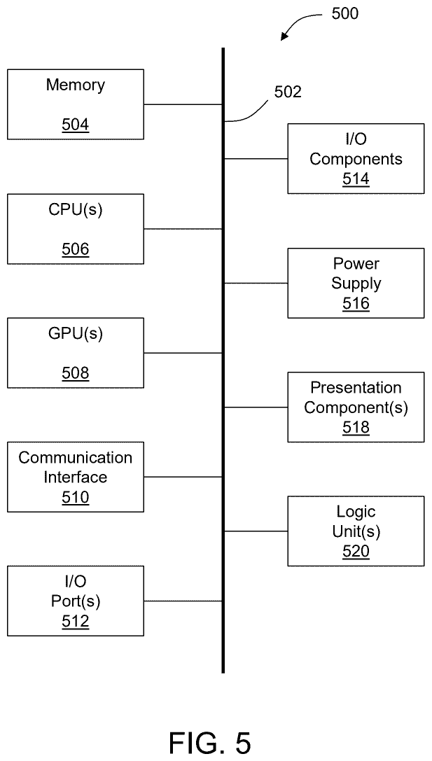

FIG. 5 is a block diagram of an example computing system 500 suitable for use in implementing some embodiments of the present disclosure. Computing system 500 may include, be included in, or be coupled to one or more of the solar trackers 102, the gateway 126, the inverter 114, and/or the combiner 116 of FIG. 1, or a processor, or other control systems discussed herein. Computing system 500 may include an interconnect system 502 that directly or indirectly couples two or more of the following devices: memory 504, one or more central processing units (CPUs) 506, one or more graphics processing units (GPUs) 508, a communication interface 510, input output (I/O) ports 512, I/O components 514, a power supply 516, one or more presentation components 518 (e.g., display(s)), and one or more logic units 520.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing system of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “augmented reality system,” and/or other device or system types, as all are contemplated within the scope of the computing system of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing system 500.

The memory 504 may include any of a variety of computer-readable media. The computer-readable media may be any available media that may be accessed by the computing system 500. The computer-readable media may include both volatile and nonvolatile media, and removable and non-removable media. By way of example, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing system 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing system 500 (or other devices or systems to which the computing system 500 may be coupled) to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing system 500 implemented (e.g., processors with fewer cores for mobile devices and processors with more cores for servers). For example, depending on the type of computing system 500, the processor may be an Advanced RISC Machines (ARM) processor implemented using Reduced Instruction Set Computing (RISC) or an x85 processor implemented using Complex Instruction Set Computing (CISC). The computing system 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing system 500 (or other devices or systems to which the computing system 500 may be coupled) to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing system 500 to render graphics (e.g., 10D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing system 500 (or other devices or systems to which the computing system 500 may be coupled) to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), I/O elements, peripheral component interconnect (PCI) or peripheral component interconnect express (PCIe) elements, and/or the like.

The communication interface 510 may include one or more receivers, transmitters, and/or transceivers that enable the computing system 500 to communicate with other computing systems via an electronic communication network, including wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 512 may enable the computing system 500 to be logically coupled to other devices including the I/O components 514, the presentation component(s) 518, and/or other components, some of which may be built into (e.g., integrated in) the computing system 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing system 500. The computing system 500 may include depth cameras, such as stereoscopic camera systems, infrared camera systems, RGB camera systems, touchscreen technology, and combinations of these, for gesture detection and recognition. Additionally, the computing system 500 may include accelerometers or gyroscopes (e.g., as part of an inertia measurement unit (IMU)) that enable detection of motion. In some examples, the output of the accelerometers or gyroscopes may be used by the computing system 500 to render immersive augmented reality or virtual reality.

The power supply 516 may include a hard-wired power supply, a battery power supply, or a combination thereof. The power supply 516 may provide power to the computing system 500 to enable the components of the computing system 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

Modifications, additions, or omissions may be made to FIG. 5 without departing from the scope of the present disclosure. For example, the computing system 500 may include more or fewer elements depending on the implementation. Further, the computing system 500 may be configured to perform any number of operations as compared to those explicitly described.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing systems, etc. The disclosure may also be practiced in distributed computing environments where tasks are performed by remote-processing devices that are linked through a communications network.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of tracker angle adjustment based on solar module monitoring, the method comprising:
obtaining, at different angular positions of a tracker throughout a day, a current measurement and a voltage measurement of a solar module in a row of solar modules coupled to the tracker;
for each of the different angular positions of the tracker, calculating a power of the solar module based on the current measurement and the voltage measurement obtained for the tracker at a corresponding one of the different angular positions; and
periodically adjusting the tracker to a new angular position for ongoing operation until a next periodic adjustment based on calculated powers of the solar module for the tracker at different positions.

2. The method of claim 1, wherein the new angular position has a calculated power that is greater than a calculated power for the tracker at a first adjacent angular position to one side of the new angular position and greater than a calculated power for the tracker at a second adjacent angular position to an opposite side of the new angular position.

3. The method of claim 1, wherein periodically adjusting the tracker to the new angular position is based on at least three calculated powers for the solar module, including a first calculated power for the tracker at a pre-adjustment angular position, a second calculated power for the tracker at an initial adjusted angular position, and a third calculated power for the tracker at a further adjusted angular position, the new angular position corresponding to the pre-adjustment angular position, the initial adjusted angular position, or the further adjusted angular position with a highest calculated power.

4. The method of claim 1, further comprising obtaining an irradiance measurement at different angular positions of the tracker throughout the day, wherein periodically adjusting the tracker to the new angular position for ongoing operation until the next periodic adjustment is further based on one or more irradiance measurements.

5. The method of claim 1, further comprising periodically adjusting the tracker to the new angular position for ongoing operation until a next periodic adjustment based on a lookup table specific to a location of the tracker, the lookup table specifying optimal tracker angular positions for specific days and times at the location, wherein for any given periodic adjustment, the calculated powers include a calculated power for the tracker at an optimum tracker angular position specified in the lookup table for a current day and time.

6. The method of claim 1, further comprising:
obtaining, at the different angular positions of the tracker throughout the day, a current measurement and a voltage measurement of a second solar module in the row of solar modules;
for each of the different angular positions of the tracker, calculating a power of the second solar module based on the current measurement and the voltage measurement obtained for the second solar module with the tracker at the corresponding one of the different angular positions; and
calculating an average power for the tracker at each of the different angular positions from the calculated power of the solar module and the calculated power of the second solar module;
wherein periodically adjusting the tracker to the new angular position for ongoing operation until the next periodic adjustment is based on the calculated average powers of the solar module and the second solar module for the tracker at the different positions.

7. The method of claim 1, further comprising:
obtaining, at the different angular positions of the tracker throughout the day, a current measurement and a voltage measurement of a second solar module in the row of solar modules;
for each of the different angular positions of the tracker, calculating a power of the second solar module based on the current measurement and the voltage measurement obtained for the second solar module with the tracker at the corresponding one of the different angular positions; and
determining a greatest calculated power between the solar module and the second solar module at each of the different angular positions;
wherein periodically adjusting the tracker to the new angular position for ongoing operation until the next periodic adjustment is based on the greatest calculated powers.

8. A method of tracker angle adjustment based on solar module monitoring, the method comprising:
periodically adjusting an angular position of a tracker having a row of solar modules coupled thereto throughout a day, including, for each periodic adjustment:
obtaining a current measurement and a voltage measurement of one of the solar modules in the row at each of multiple different angular positions of the tracker;
calculating different powers of the one of the solar modules corresponding to the different angular positions of the tracker, each of the different powers determined based on the current measurement and the voltage measurement for the tracker at a given one of the different angular positions; and
positioning the tracker at an angular position for ongoing operation until a next periodic adjustment based on the different powers.

9. The method of claim 8, wherein the angular position at which the tracker is positioned for ongoing operation until the next periodic adjustment has a calculated power that is greater than a calculated power for the tracker at a first adjacent angular position to one side of the angular position and greater than a calculated power for the tracker at a second adjacent angular position to an opposite side of the angular position.

10. The method of claim 8, wherein the different powers calculated for each periodic adjustment include at least a first calculated power for the tracker at a pre-adjustment angular position, a second calculated power for the tracker at an initial adjusted angular position, and a third calculated power for the tracker at a further adjusted angular position, the angular position at which the tracker is positioned for ongoing operation until the next periodic adjustment corresponding to the pre-adjustment angular position, the initial adjusted angular position, or the further adjusted angular position with a highest calculated power.

11. The method of claim 8, further comprising obtaining an irradiance measurement at different angular positions of the tracker throughout the day, wherein positioning the tracker at the angular position for ongoing operation until the next periodic adjustment is further based on one or more irradiance measurements.

12. The method of claim 8, wherein:
periodically adjusting the angular position further includes, for each periodic adjustment, looking up an optimal tracker angular position for a current day and current time in a lookup table that specifies optimal tracker angular positions for different days and times at a location of the tracker; and
for each periodic adjustment, the multiple different angular positions of the tracker at which a current measurement and a voltage measurement of the one of the solar modules is obtained include the optimal tracker angular position in the lookup table for the current day and current time.

13. The method of claim 8, further comprising, for each periodic adjustment:
obtaining a current measurement and a voltage measurement of a second solar module in the row at each of the multiple different angular positions of the tracker;
calculating different powers of the second solar module corresponding to the different angular positions of the tracker, each of the different powers determined based on the current measurement and the voltage measurement for the second solar module with the tracker at the given one of the different angular positions; and
calculating an average power for the tracker at each of the different angular positions from the corresponding calculated powers of the one of the solar modules and the second solar module;
wherein positioning the tracker at the angular position for ongoing operation until the next periodic adjustment is based on the average powers.

14. The method of claim 8, further comprising, for each periodic adjustment:
obtaining a current measurement and a voltage measurement of a second solar module in the row at each of the multiple different angular positions of the tracker;
calculating different powers of the second solar module corresponding to the different angular positions of the tracker, each of the different powers determined based on the current measurement and the voltage measurement for the second solar module with the tracker at the given one of the different angular positions; and
determining a greatest calculated power between the one of the solar modules and the second solar module at each of the different angular positions;
wherein positioning the tracker at the angular position for ongoing operation until the next periodic adjustment is based on the greatest calculated powers.

15. A method of tracker angle adjustment based on solar module monitoring, the method comprising:
periodically adjusting an angular position of a tracker having a row of solar modules coupled thereto throughout a day according to a pre-set schedule based on a lookup table for a given location, the lookup table specifying optimal tracker angular positions at the given location for different days and times;
before each adjustment, obtaining a pre-adjustment current measurement and voltage measurement of one of the solar modules of the row for the tracker at a pre-adjustment angular position;
adjusting the tracker angular position to an initial adjusted angular position specified as the optimal tracker angular position in the lookup table for a current day and current time;
obtaining an initial adjusted current measurement and voltage measurement of the one of the solar modules of the row for the tracker at the initial adjusted angular position;
adjusting the tracker angular position to a further adjusted angular position beyond the initial adjusted angular position;
obtaining a further adjusted current measurement and voltage measurement of the one of the solar modules of the row for the tracker at the further adjusted angular position;
calculating a pre-adjustment power, an initial adjusted power, and a further adjusted power of the one of the solar modules at each of the pre-adjustment angular position, the initial adjusted angular position, and the further adjusted angular position from the current measurement and voltage measurement obtained at each angular position; and
in response to the initial adjusted power being greater than each of the pre-adjustment power and the further adjusted power, adjusting the tracker angular position back to the initial adjusted angular position and keeping the tracker at the initial adjusted angular position until a next periodic adjustment of the tracker angular position according to the lookup table.

16. The method of claim 15, further comprising, in response to the further adjusted power being greater than each of the pre-adjustment power and the initial adjusted power:
adjusting the tracker angular position to a third adjusted angular position beyond the further adjusted angular position;
obtaining a third adjusted current measurement and voltage measurement of the one of the solar modules of the row for the tracker at the third adjusted angular position;
calculating a third adjusted power of the one of the solar modules at the third adjusted angular position from the third adjusted current measurement and voltage measurement obtained at the third adjusted angular position; and
in response to the further adjusted power being greater than each of the initial adjusted power and the third adjusted power, adjusting the tracker angular position back to the further adjusted angular position and keeping the tracker at the further adjusted angular position until the next periodic adjustment of the tracker angular position according to the lookup table.

17. The method of claim 15, further comprising obtaining irradiance measurements for the tracker at the pre-adjustment angular position, the initial adjusted angular position, and the further adjusted angular position, wherein adjusting the tracker angular position back to the initial adjusted angular position and keeping the tracker at the initial adjusted angular position until the next periodic adjustment is further based on the irradiance measurements.

18. The method of claim 15, further comprising:
obtaining a pre-adjustment current measurement and voltage measurement of a second solar module of the row for the tracker at the pre-adjustment angular position;
obtaining an initial adjusted current measurement and voltage measurement of the second solar module of the row for the tracker at the initial adjusted angular position;
obtaining a further adjusted current measurement and voltage measurement of the second solar module of the row for the tracker at the further adjusted angular position;
calculating a pre-adjustment power, an initial adjusted power, and a further adjusted power of the second solar module at each of the pre-adjustment angular position, the initial adjusted angular position, and the further adjusted angular position from the current measurement and voltage measurement obtained at each angular position;
calculating an average pre-adjustment power from the pre-adjustment power of the one of the solar modules and the pre-adjustment power of the second solar module;
calculating an average initial adjusted power from the initial adjusted power of the one of the solar modules and the initial adjusted power of the second solar module;
calculating an average further adjusted power from the further adjusted power of the one of the solar modules and the further adjusted power of the second solar module;
wherein, in response to the average initial adjusted power being greater than each of the average pre-adjustment power and the average further adjusted power, adjusting the tracker angular position back to the initial adjusted angular position and keeping the tracker at the initial adjusted angular position until a next periodic adjustment of the tracker angular position according to the lookup table.

19. The method of claim 15, further comprising:
obtaining a pre-adjustment current measurement and voltage measurement of a second solar module of the row for the tracker at the pre-adjustment angular position;
obtaining an initial adjusted current measurement and voltage measurement of the second solar module of the row for the tracker at the initial adjusted angular position;
obtaining a further adjusted current measurement and voltage measurement of the second solar module of the row for the tracker at the further adjusted angular position;
calculating a pre-adjustment power, an initial adjusted power, and a further adjusted power of the second solar module at each of the pre-adjustment angular position, the initial adjusted angular position, and the further adjusted angular position from the current measurement and voltage measurement obtained at each angular position;
determining a greatest pre-adjustment power from the pre-adjustment power of the one of the solar modules and the pre-adjustment power of the second solar module;
determining a greatest initial adjusted power from the initial adjusted power of the one of the solar modules and the initial adjusted power of the second solar module;
determining a greatest further adjusted power from the further adjusted power of the one of the solar modules and the further adjusted power of the second solar module;
wherein, in response to the greatest initial adjusted power being greater than each of the greatest pre-adjustment power and the greatest further adjusted power, adjusting the tracker angular position back to the initial adjusted angular position and keeping the tracker at the initial adjusted angular position until a next periodic adjustment of the tracker angular position according to the lookup table.

20. A non-transitory computer-readable medium comprising computer-readable instructions executable by a processor to perform or control performance of the method of claim 16.
